(19) United States
(12) Patent Application Publication
(10) Pub. No.: US 2002/0083691 A1
(43) Pub. Date: Jul. 4, 2002

(54) Oil filter device of smoke exhaust

(76) Inventor: Li-Lin Chang, Taichung Hsien (TW)

Correspondence Address: ROSENBERG, KLEIN & LEE, SUITE 101, 3458 ELLICOTT CENTER DRIVE, ELLICOTT CITY, MD, 21043, US

(21) Appl. No.: 09/749,530

(22) Filed: Dec. 28, 2000

(51) Int. Cl. B01D 46/00

(52) U.S. Cl. 55/385.1

(57) ABSTRACT

An oil filter device of smoke exhaust including a smoke collecting funnel, a fan and a filter device. The filter device includes an upright hollow casing in which a frame assembly is disposed. A filter mesh is disposed along the circumference of the frame assembly. The outer circumference and the inner circumference of the casing define therebetween a venting space. The smoke gets into the frame assembly and passes through the filter mesh into the venting space and then is exhausted from a perforated section of the casing so as to filter off the oil.

### BACKGROUND OF THE INVENTION

The present invention is related to an oil filter device of smoke exhaust. The filter device is installed in the smoke exhaust pipe and is able to filter off the oil and prevent the oil dirt from dropping down.

FIG. 8 shows a conventional smoke exhaust. A fan and a motor (not shown) are mounted in the casing 71 of the smoke exhaust. The smoke is sucked into the inlets 72 of the bottom of the casing 71 through the internal passage thereof and then exhausted from the exhaustion pipe 73.

Such smoke exhaust has no filtering function so that it can only exhaust smoke, while failing to filter the smoke. Accordingly, the bottom face of the casing 71, the internal passage, the fan and the exhaustion pipe 73 will be contaminated by a great amount of oil dirt. When the oil dirt accumulates to a certain extent, the function of the smoke exhaust will be greatly deteriorated. In addition, the oil dirt will drop onto the kitchen cabinet to pollute the environment of the kitchen. Also, the smoke exhausted outside will lead to problem of environmental protection.

Furthermore, the inlets 72 are free from any shield. In use, in case an alien article or a user's hand is incautiously extended into the inlets 72, the fan in the casing 71 will hit the alien article or the user's hand to result in damage or injury.

FIG. 9 shows another type of smoke exhaust. The inlet 82 of the casing 81 is covered by a conic protective mesh 83. An oil collecting cup 84 is disposed on the bottom of the protective mesh 83. The protective mesh 83 serves to prevent the alien article or the user's hand from getting into the inlet 82. In addition, the conic protective mesh 83 is able to partially guide the oil dirt to flow into the oil collecting cup 84. The protective mesh 83 can filter the oil. However, when the oil dirt accumulates to a certain extent, the oil will still drop down. A part of the oil will be stopped by the protective mesh 83 to flow along the protective mesh 83 into the oil collecting cup 84. However, other part of the oil dirt will still drop onto the kitchen cabinet to contaminate environment or foods. Such smoke exhaust has poor filtering function so that the exhausted smoke still contain a great amount of oil particles which will result in pollution of air.

FIG. 10 shows still another type of conventional smoke exhaust. An oil filter mesh 92 is disposed at the inlet of the bottom face of the casing 91. The oil filter mesh 92 is formed by multiple layers of metal meshes which have different sizes of meshes and overlapping each other. When the smoke passes through the oil filter mesh 92, the oil particles are stopped by the oil filter mesh 92 to attach thereto. After a period of use, a user must take off and wash the oil filter mesh 92. The oil filter mesh 92 is hard to clean so that it is still inconvenient to use such smoke exhaust.

### SUMMARY OF THE INVENTION

It is therefore a primary object of the present invention to provide an oil filter device of smoke exhaust. The casing of the filter device is upright arranged so that the frame assembly and the filter mesh disposed on the circumference of the frame assembly are both upright positioned in the casing. The outer circumference and the inner circumference of the casing define therebetween a venting space. The smoke gets into the frame assembly and passes through the filter mesh into the venting space and then is exhausted from a perforated section of the casing. Therefore, the oil particles entrained by the smoke can be stopped and filtered off by the filter mesh. The filtered off oil particles will quickly collectively flow down along the upright filter mesh. Therefore, it is unnecessary to frequently wash or replace the filter mesh. The present invention is able to achieve both quick oil filtering effect and easy oil-collecting effect.

The present invention can be best understood through the following description and accompanying drawings wherein:

### BRIEF DESCRIPTION OF THE DRAWINGS

FIG. 1 is a perspective assembled view of the present invention;

FIG. 2 is a perspective exploded view of the present invention;

FIG. 3 is a sectional view taken along line III-III of FIG. 1;

FIG. 4 is a perspective exploded view of a second embodiment of the present invention;

FIG. 5 is a perspective exploded view of a third embodiment of the present invention;

FIG. 6 is a perspective exploded view of a fourth embodiment of the present invention;

FIG. 7 is a sectional assembled view of the fourth embodiment of the present invention;

FIG. 8 is a perspective view of a conventional smoke exhaust;

FIG. 9 is a perspective view of another type of conventional smoke exhaust; and

FIG. 10 is a perspective view of still another type of conventional smoke exhaust.

### DETAILED DESCRIPTION OF THE PREFERRED EMBODIMENTS

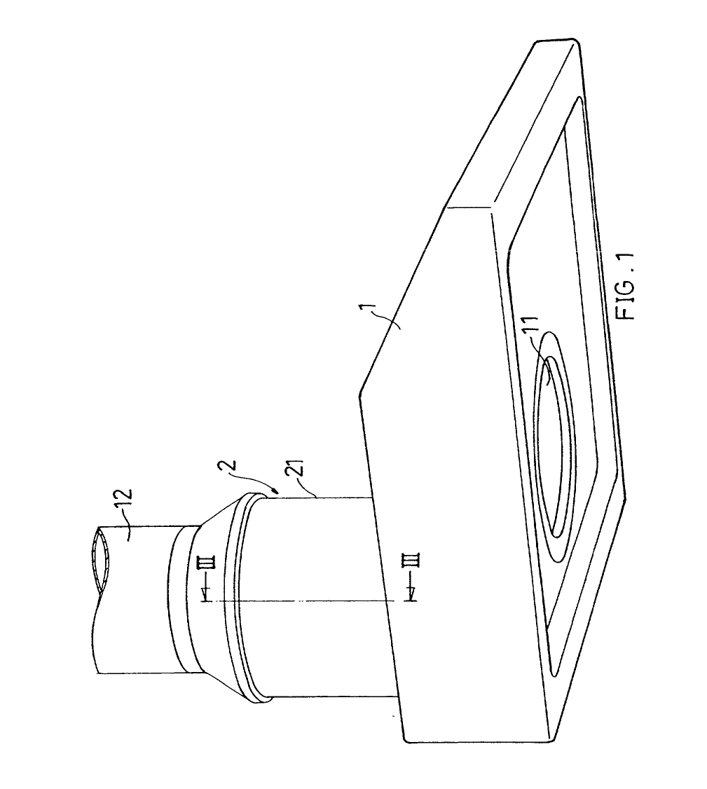

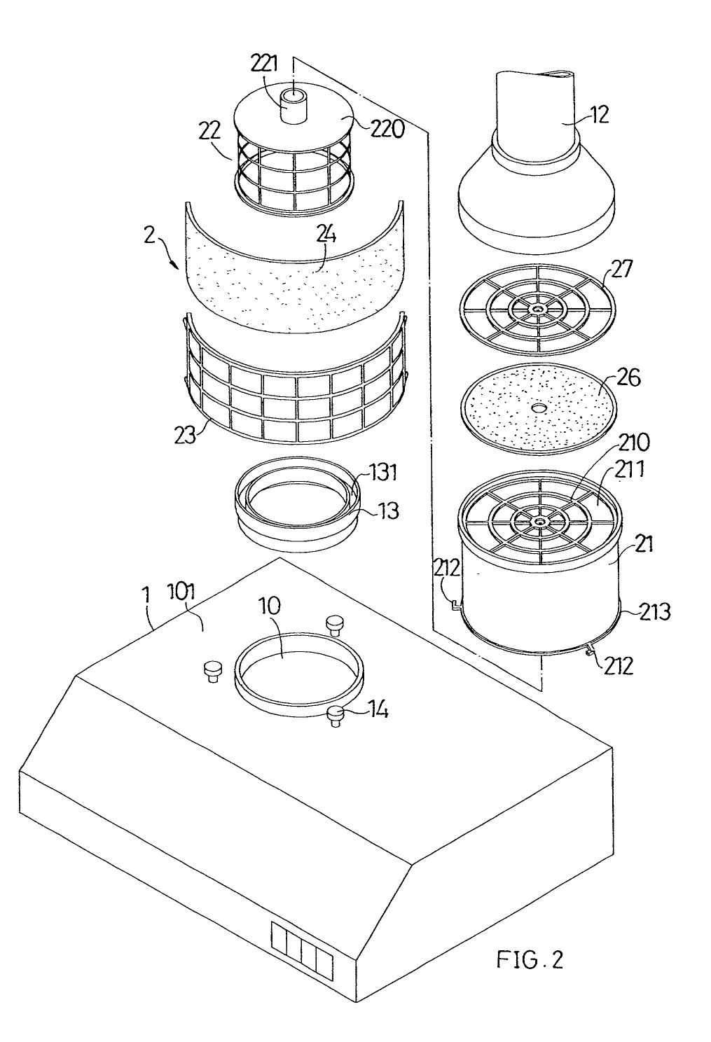

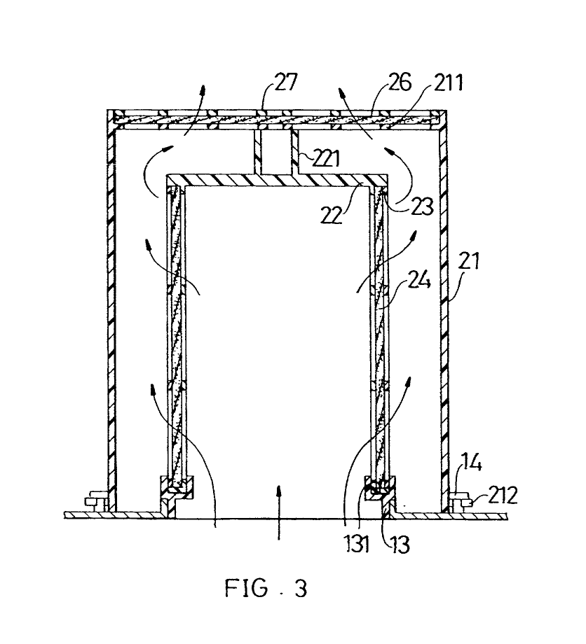

Please refer to FIGS. 1 to 3. According to a preferred embodiment of the present invention, the oil filter device of smoke exhaust includes a smoke collecting funnel 1, a fan (not shown) and a filter device 2 communicating with the smoke collecting funnel 1. The filter device 2 includes an upright hollow casing 21. The casing 21 has a top face 210 formed with a perforated section 211. An inner frame 22 and an outer frame 23 formed with perforated peripheries are disposed in the casing 21. The inner frame 22 is enclosed in a filter mesh 24. The outer frame 23 covers and fixes the filter mesh 24 and is fastened around the inner frame 22. The smoke collecting funnel 1 has a top face 101 formed with an outlet 10. A fixing ring 13 is fastened around the outlet 10. The fixing ring 13 is formed with an annular groove 131 in which the inner and outer frames 22, 23 and the filter mesh 24 are inlaid and located. The casing 21 has a bottom section 213 equipped with several hooks 212. The top face 101 of the smoke collecting funnel 1 is equipped with several pins 14 corresponding to the hooks 212 for engaging therewith. Accordingly, the casing 21 of the filter device 2 can be fastened on the top face 101 of the smoke collecting funnel 1. The outer frame 23 and the casing 21 define therebetween a venting space 25. The inner frame 22 has a top face 220 formed with an upward extending locating section 221 for abutting against the casing 21 to locate the inner frame 22. In addition, an upper filter mesh 26 is disposed on the perforated section 211 of the casing 21 and fixed thereon by a mesh rack 27. In this embodiment, the upper filter mesh 26 is an activated carbon filter mesh. In addition, if it is necessary to exhaust the filtered air outdoors, a smoke exhaust pipe 12 can be additionally disposed on the filter device 2 for guiding the filtered air to be exhausted.

When the smoke is sucked into the inlet 11 of the smoke collecting funnel 1 and exhausted from the outlet 10, the smoke will get into the filter device 2 from the inner side of the inner frame 22. The smoke then passes through the filter mesh 24 into the venting space 25. When the smoke passes through the filter mesh 24, the oil particles entrained by the smoke will be stopped by and filtered off by the filter mesh 24. The filtered air then passes through the upper filter mesh 26 on the perforated section 211 of the casing 21. The activated carbon filter mesh 26 serves to filter off the odor. Therefore, the filtered air will not contaminate the environment and can be circulated indoors or guided by and exhausted from the smoke exhaust pipe 12. The filtered off oil particles will accumulate on the filter mesh 24. When the oil particles accumulates to a certain extent, the oil particles will flow downward along the upright filter mesh 24 due to its own weight. The filter mesh 24 is positioned upright so that the oil dirt will only flow down along the filter mesh 24 without scattering around. The oil dirt is then collected in the bottom of the filter mesh 24. Accordingly, the present invention can achieve both filtering effect and oil-collecting effect. After a period of use, the filtering function of the filter mesh 24 will be deteriorated due to accumulating oil. At this time, a user can rotate the casing 21 to detach the hooks 212 from the pins 14 and take off the casing 21. Then the filter mesh 24 and the upper filter mesh 26 can be replaced with new ones.

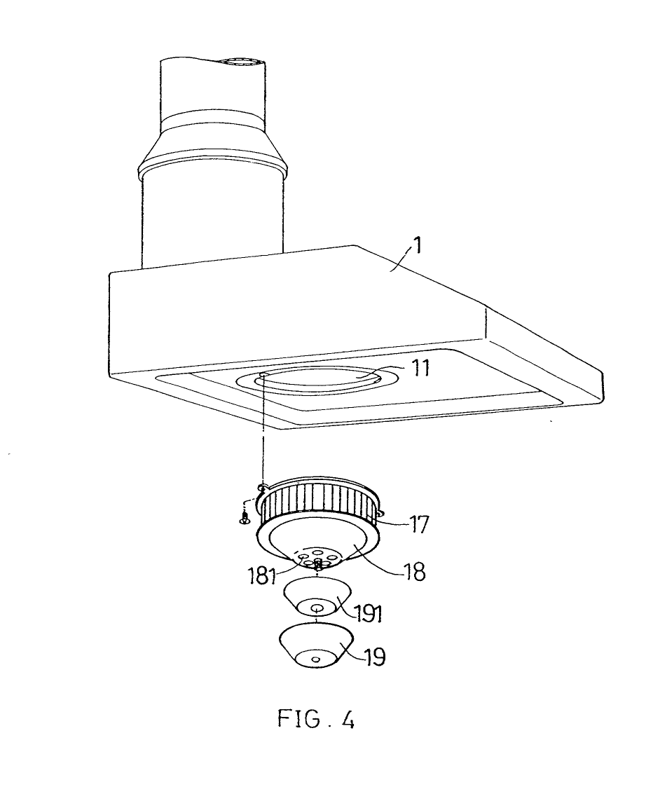

FIG. 4 shows a second embodiment of the present invention, in which a downward extending vertical protective mesh 17 is disposed at the inlet 11. The protective mesh 17 has a substantially conic base tray 18. The trough section of the base tray 18 is formed with multiple oil draining holes 181. The base tray 18 is further equipped with an oil collecting cup 19 corresponding to the oil draining holes 181. A disposable oil cup 191 is inlaid in the oil collecting cup 19. According to the above arrangement, the second embodiment not only can achieve the same effect as the first embodiment, but also can provide a protective effect for the inlet 11. Therefore, an alien article or the user's hand is prevented from getting into the inlet 11. Moreover, the protective mesh 17 is upright so that when excessive oil spills out of the filter device 2, the protective mesh 17 can more quickly guide the oil to flow downward into the base tray 18 without dropping onto the kitchen cabinet or foods.

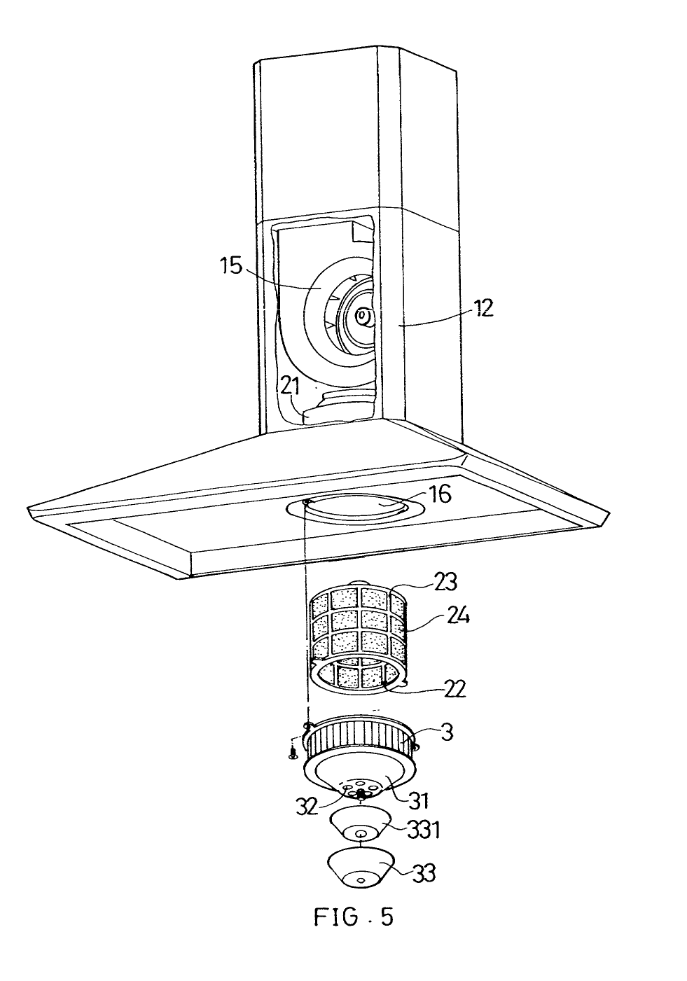

FIG. 5 shows a third embodiment of the present invention, in which the fan 15 is disposed in the smoke exhaust pipe 12 above the filter device 2. The inner and outer frames 22, 23 and filter mesh 24 of the filter device 2 are installed from the inlet 16 of lower side of the smoke collecting funnel 1 into the casing 21 disposed in the smoke exhaust pipe 12. A protective mesh 3 is locked at the inlet 16 of the smoke collecting funnel 1. Accordingly, the filter device 2 is stopped by the partitioning board 121 and protective mesh 3 in the smoke collecting funnel 1 and fixed therein. The protective mesh 3 is a substantially upright barrel body and has a substantially conic base tray 31. The trough section of the base tray 31 is formed with multiple oil draining holes 32. The base tray 31 is further equipped with an oil collecting cup 33 corresponding to the oil draining holes 32. A disposable oil cup 331 is inlaid in the oil collecting cup 33. According to the above arrangement, the third embodiment can achieve the same effect as the above embodiments. When it is desired to replace the filter mesh 24, the protective mesh 3 is detached and the filter device 2 is taken out for replacement of the filter mesh 24.

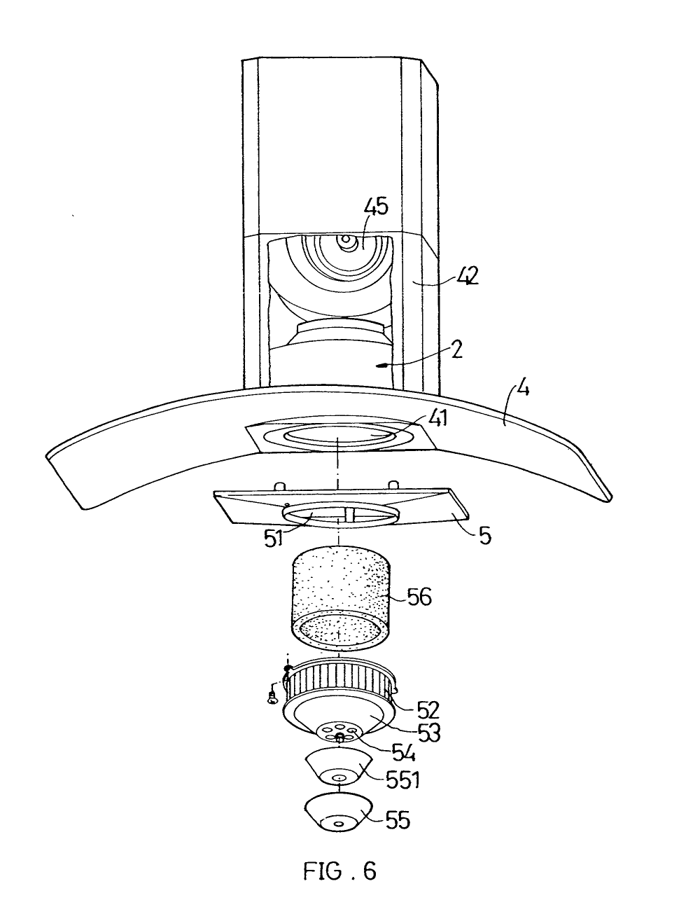

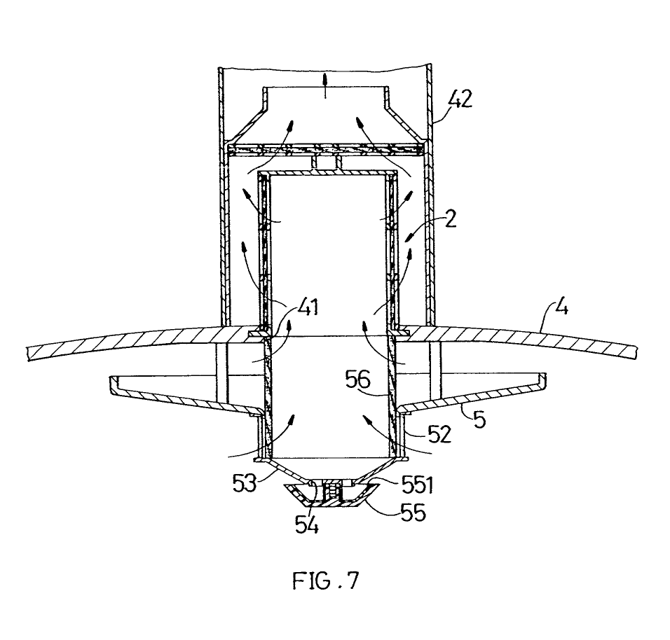

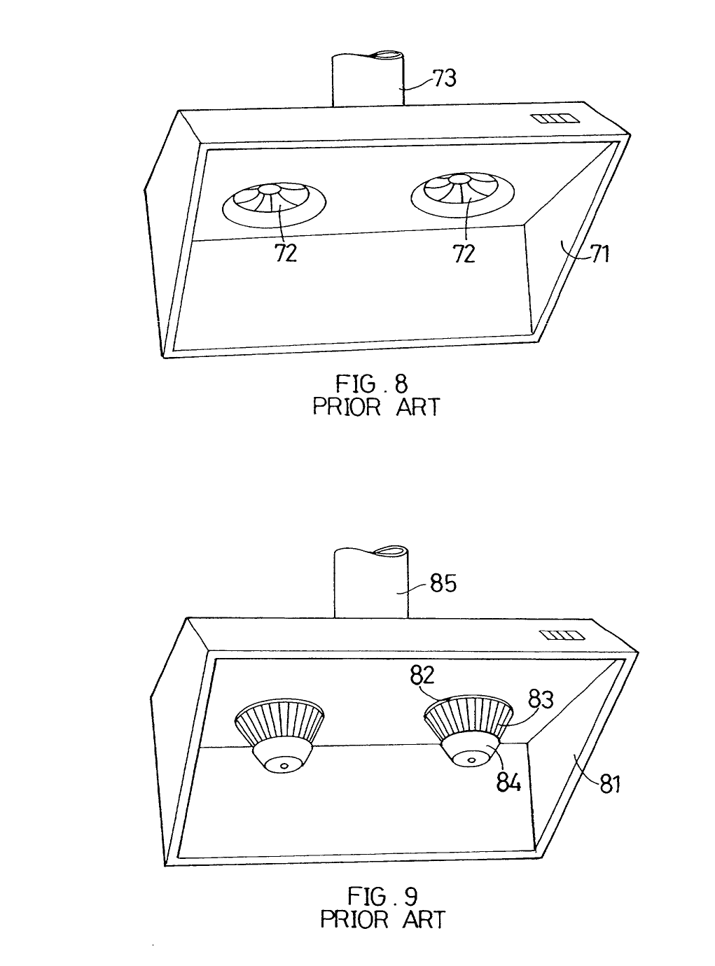

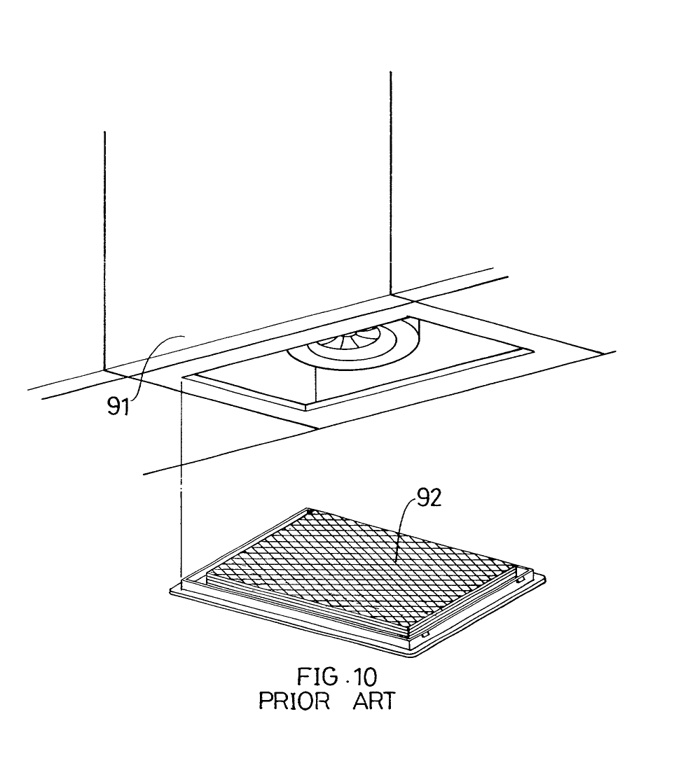

FIGS. 6 and 7 show a fourth embodiment of the present invention, in which the fan 45 is disposed in the smoke exhaust pipe 42 above the filter device 2. A partitioning board 5 is disposed under the inlet 41 of the smoke collecting funnel 4. The partitioning board 5 and the smoke collecting funnel 4 define therebetween a gap for venting the air. The partitioning board 5 is basin-like, having a lower central portion and higher peripheral portion. The central lower portion of the partitioning board 5 is formed with a hole 51. An upright barrel-like mesh rack 52 is correspondingly disposed at the hole 51. The mesh rack 52 has a conic base tray 53. The trough section of the base tray 53 is formed with multiple oil draining holes 54. The base tray 53 is further equipped with an oil collecting cup 55 corresponding to the oil draining holes 54. A disposable oil cup 551 is inlaid in the oil collecting cup 55. A lower filter mesh 56 is disposed in the mesh rack 52. The lower filter mesh 56 upward extends through the partitioning board 5 to the inlet 41 of the smoke collecting funnel 4. According to the above arrangement, the fourth embodiment can achieve the same effect as the first embodiments. In addition, by means of guiding of the partitioning board 5, the smoke sucking range is enlarged. Moreover, the lower filter mesh 56 serves to preliminarily filter off the oil and cooperate with the mesh rack 52 to enhance the protection and hygiene.

The above embodiments are only used to illustrate the present invention, not intended to limit the scope thereof. Many modifications of the above embodiments can be made without departing from the spirit of the present invention.

What is claimed is:

1. An oil filter device of smoke exhaust comprising a smoke collecting funnel, a fan and a smoke exhaust pipe, a filter device being disposed in the smoke exhaust pipe, the filter device including an upright hollow casing which has a top face formed with a perforated section, an upright perforated frame assembly being disposed in the casing, the frame assembly having a filter mesh, the frame assembly and the casing defining therebetween a venting space, whereby the smoke gets into the frame assembly from the smoke exhaust pipe and passes through the filter mesh into the venting space and then is exhausted from the perforated section of the casing.

2. An oil filter device of smoke exhaust as claimed in claim 1, wherein the frame assembly includes an inner frame and an outer frame, the inner frame being enclosed in the filter mesh, the outer frame covering and fixing the filter mesh on the inner frame.

3. An oil filter device of smoke exhaust as claimed in claim 1, wherein the frame assembly has a top section formed with an upward extending locating section, the locating section abutting against the ca sing to locate the frame assembly therein.

4. An oil filter device of smoke exhaust as claimed in claim 1, further comprising an upper filter mesh disposed on the perforated section of top face of the casing and fixed thereon by a mesh rack.

5. An oil filter device of smoke exhaust as claimed in claim 1, wherein the smoke collecting funnel has a top face on which the filter device is disposed, the top face being formed with an outlet, a fixing ring being fastened around the outlet, the fixing ring being formed with an annular groove in which the frame assembly and the filter mesh of the filter device are inlaid and located.

6. An oil filter device of smoke exhaust as claimed in claim 1, wherein the casing has a bottom section equipped with several hooks, the smoke collecting funnel having a top face formed with an outlet and equipped with several pins corresponding to the hooks for engaging therewith.

7. An oil filter device of smoke exhaust as claimed in claim 1, wherein the smoke collecting funnel is formed with an inlet, an upright mesh rack being disposed at the inlet, the mesh rack being substantially barrel-like and having a conic base tray, a trough section of the base tray being formed with at least one oil draining hole, the base tray being equipped with an oil collecting cup corresponding to the oil draining hole, an upright filter mesh being disposed on inner circumference of the mesh rack.

8. An oil filter device of smoke exhaust as claimed in claim 1, wherein the smoke collecting funnel is formed with an inlet, a partitioning board being disposed under the inlet of the smoke collecting funnel, the partitioning board and the smoke collecting funnel defining therebetween a gap for venting the air, the partitioning board being basin-like, having a lower central portion and higher peripheral portion, the central lower portion of the partitioning board being formed with a hole, an oil collecting cup corresponding to the hole being disposed at the hole.

9. An oil filter device of smoke exhaust as claimed in claim 7, wherein a disposable oil cup is inlaid in the oil collecting cup.

10. An oil filter device of smoke exhaust as claimed in claim 8, wherein an upright downward extending barrel-like mesh rack is disposed at the hole of the partitioning board, the mesh rack having a conic base tray, a trough section of the base tray being formed with at least one oil draining hole, the base tray being equipped with an oil collecting cup corresponding to the oil draining hole, a filter mesh being disposed in the mesh rack, the filter mesh upward extending through the partitioning board to the inlet of the smoke collecting funnel.
